(19) United States
(12) Patent Application Publication
(10) Pub. No.: US 2018/0072863 A1
(43) Pub. Date: Mar. 15, 2018

(54) METHOD OF MAKING GRAPHENE COMPOSITIONS

(71) Applicant: VORBECK MATERIALS, Jessup, MD (US)

(72) Inventors: Dan F Scheffer, Frederick, MD (US); Kate Redmond, Baltimore, MD (US)

(73) Assignee: VORBECK MATERIALS CORP., Jessup, MD (US)

(21) Appl. No.: 15/564,700

(22) PCT Filed: Apr. 6, 2015
(86) PCT No.: PCT/US15/24587

§ 371 Date: Oct. 5, 2017

(51) Int. Cl. C08K 3/04; C08K 5/01; C08K 5/04; C09D 11/52; C09D 11/037; C09D 7/12; C09D 5/24; C01B 32/194

(52) U.S. Cl. CPC C08K 3/042; C08K 5/01; C08K 5/04; C09D 11/52; C01B 32/20; C09D 7/1291; C09D 5/24; C01B 32/194; C08K 2201/006; C09D 11/037

(57) ABSTRACT

A method of making a composition, comprising blending a mixture comprising graphene sheets, one or more cyclic compounds having at least one ring having two or more conjugated double and/or triple bonds, and at least one solvent, wherein the one or more cyclic compounds have a solubility of no more than about 5 percent, based on the weight of the one or more cyclic compounds and solvent.

### CROSS-REFERENCE TO RELATED APPLICATIONS

This application is a 371 application of International Application No. PCT/U.S.15/24587 filed Apr. 6, 2015, which is hereby incorporated herein by reference.

### FIELD OF THE INVENTION

The present invention relates to a method of making a graphene composition.

### SUMMARY OF THE INVENTION

Disclosed and claimed herein is a method of making a composition, comprising blending a mixture comprising graphene sheets, one or more cyclic compounds having at least one ring having two or more conjugated double and/or triple bonds, and at least one solvent, wherein the one or more cyclic compounds have a solubility of no more than about 5 percent, based on the weight of the one or more cyclic compounds and solvent. Further disclosed and claimed are inks and coatings and composite materials made from the composition.

### DETAILED DESCRIPTION OF THE INVENTION

Graphene sheets are dispersed in the presence of at least one cyclic compound having at least one ring having two or more conjugated double and/or triple bonds, and optionally, a solvent. The rings contain carbon atoms, and, optionally one or more heteroatoms (such as oxygen, nitrogen, sulfur, phosphorus, etc.). The cyclic compounds are different from the solvent and are preferably solids at 25 C. The rings can be aromatic rings, pseudoaromatic rings, etc. Examples of cyclic compounds include those having at least one, two, three, four, five, six, seven, eight, nine, ten, or more rings. In some cases the rings are four-, five-, six-, seven-, or eight-membered rings. The cyclic compounds can have a molecular weight of less than about 3000, or less than about 2500, or less than about 2000, or less than about 1500, or less than about 1000, or less than about 800, or less than about 500, or less than about 300.

The cyclic compounds can have one or more aromatic and/or pseudoaromatic rings. In cases where two or more rings are present, two or more aromatic rings can be fused to each other. Rings can be joined by other linking groups, such as those containing single, double, and/or triple bonds, heteroatoms, etc. One or more aliphatic/alicyclic rings many be fused to one or more aromatic rings. The cyclic compound can have at least two, three, four, five, six, seven, eight, nine, ten, or more aromatic, pseudoaromatic, and/or aliphatic rings that are fused together. In some cases, all of the rings are fused at least one other ring. In some cases all of the rings are aromatic. In some cases, all of the rings are aromatic and are fused to at least one other ring. Two or more (fused or unfused) rings can be conjugated with each other.

Examples of cyclic compounds include heteroaromatic compounds, polycyclic aromatic hydrocarbons, polycyclic heteroaromatic compounds, partially hydrogenated polycyclic aromatic or heteroaromatic compounds, etc. The cyclic compounds can be hydrocarbons and/or heterocyclic compounds that have only hydrocarbon substituents.

The cyclic compounds can be functionalized or unfunctionalized. Functionalized cyclic compounds can be substituted with one or more substituents, including reactive functional groups, such alkyl groups, alicyclic rings, groups containing double and/or triple bonds, hydroxyls, hydroperoxy and peroxy groups, carboxylic acids, carboxylic acid salts (e.g. Li, Na, K, Mg, Ca, Zn, etc. salts), esters, anhydrides, acid halides (including acid chlorides), aldehydes (e.g. formyl groups), acetals, orthoesters, carbonates, amino groups, amides, imines, imides, azides, cyanates, isocyanates, thiol groups, sulfo, sulfino, thiocyanates, expoxies, ethers, ethers, etc.

Examples of cyclic compounds include the following and their derivatives: acenaphthene, acenaphthylene, acenaphthene, anthracene, azulene, biphenylene, benz[a]anthracene, benz[b]anthracene (tetracene), benzo[a]pyrene, benzo[e]pyrene, benzo[b]fluoranthene, benzo[k]fluoranthene, 2,3-benzofluorene, 11H-benzo[a]fluorene, benzo[ghi]perylene, benzo[j]fluoranthene, benzo[k]fluoranthene, chrysene, comannulene, coronene, cyclopenta[d,e,f]phenanthrene, dibenz(a,h)anthracene, dibenzosuberane, 9,10-diphenylanthracene, dodecahydrotriphenylene, fluoranthene, fluorene, fulvene, fulvalene, helicene, 1,2,3,6,7,8-hexahydropyrene, indene, indeno(1,2,3-cd)pyrene, ovalene, naphthalene, naphtho[2,3-a]pyrene, pentacene, perylene, phenanthrene, pyrene, rubrene, triphenylene, 5,10,15,20-tetraphenylbisbenz[5,6]indeno[1,2,3-cd:1,2′,3′-lm]perylene (DBC), perylene-3,4,9,10-tetracarboxylic dianhydride, perylenedicarboximide, 1,4,5,8-naphthalenetetracarboxylic dianhydride, 1,4,5,8-naphthalenetetracarboxylic acid 1,8-monoanhydride, 1,8-naphthalic anhydride, 9,10-dihydrobenzo[a]pyrene-7(8H)-one, perylene-3,4,9,10-tetracarboxylic dianhydride, 7,8,9,10-tetrahydrobenzo[a]pyren-7-ol, 9,10-phenanthrenequinone, quinizarin, 5,8-dihydroxy-1,4-naphthoquinone, anthraquinone, 2,3-diphenylmaleic anhydride, etc.

Examples of cyclic compounds having a heteroatom in the ring system include the following and their derivatives: bathocuproine, bathophenanthroline, 3,8-diamino-6-phenylphenanthridine, phenanthridine, phenazine, phenanthroline, 1,10-phenanthroline, 1,10-phenanthroline-5,6-dione, phenylphenanthridine, 1,3,8, 10(2H,9H)-tetraone, 2,9-bis(2-phenylethyl)anthra[2,1,9-def.6,5,10-d′e′f′]diisoquinoline, melamine, pyridine, pyrimidine, triazine, pyrrole, imidazole, indole, purine, adenine, guanine, cytosine, thymine, 2,2′-bipyridyl, 5-methoxypsoralen, psoralen, furan, thiophene, dibenzotetrathiafulvalene, tetrathiafulvalene, tetrathiafulvalene 7,7,8,8-tetracyanoquinodimethane salt, 2,6-ditolylbenzo[1,2-b:4,5-b′]dithiophene, benzo[1,2-b:4,5-b′]dithiophene-4,8-dione, etc.

In some cases, the cyclic compound can have a melting point of above about 80° C., or above about 90° C., or above about 100° C., or above about 120° C., or above about 140° C., or above about 160° C., or above about 180° C., or above about 200° C.

In some cases, the cyclic compound can be present in from about 1 to about 99 percent, or from about 10 to about 99 percent, or from about 20 to about 99 percent, from about 30 to about 99 percent, or from about 40 to about 99 percent, or from about 50 to about 99 percent, or from about 60 to about 99 percent, or from about 70 to about 99 percent, or from about 80 to about 99 percent, or from about 85 to about 99 percent, or from about 90 to about 99 percent, or from about 1 to about 95 percent, or from about 10 to about 95 percent, or from about 20 to about 95 percent, from about 30 to about 95 percent, or from about 40 to about 95 percent, or from about 50 to about 95 percent, or from about 60 to about 95 percent, or from about 70 to about 95 percent, or from about 80 to about 95 percent, or from about 85 to about 95 percent, or from about 90 to about 95 percent, or from about 1 to about 80 percent, or from about 10 to about 80 percent, or from about 20 to about 80 percent, from about 30 to about 80 percent, or from about 40 to about 80 percent, or from about 50 to about 80 percent, or from about 60 to about 80 percent, or from about 70 to about 80 percent, or from about 1 to about 70 percent, or from about 10 to about 70 percent, or from about 20 to about 70 percent, from about 30 to about 70 percent, or from about 40 to about 70 percent, or from about 50 to about 70 percent, or from about 60 to about 70 percent, or from about 1 to about 60 percent, or from about 10 to about 60 percent, or from about 20 to about 60 percent, from about 30 to about 60 percent, or from about 40 to about 60 percent, or from about 50 to about 60 percent, or from about 1 to about 50 percent, or from about 10 to about 50 percent, or from about 20 to about 50 percent, from about 30 to about 50 percent, or from about 40 to about 50 percent, or from about 1 to about 40 percent, or from about 10 to about 40 percent, or from about 20 to about 40 percent, from about 30 to about 40 percent, from about 1 to about 30 percent, or from about 10 to about 30 percent, or from about 20 to about 30 percent, or from about 1 to about 20 percent, or from about 10 to about 20 percent, or from about 1 to about 10 percent, based on the total weight of cyclic compound and graphene sheets plus graphite, if present.

Graphite is made up of many layers of graphene, which are one-atom thick sheets of carbon atoms arranged in a hexagonal lattice. As used herein, the term “graphene sheets” refers to materials having one or more layers of graphene that have a surface area of from about 100 to about 2630 m²/g. The graphene sheets can comprise mixtures of fully and partially exfoliated graphite sheets. Graphene sheets are distinct from carbon nanotubes. Graphene sheets can have a “platy” (e.g. two-dimensional) structure and do not have the needle-like form of carbon nanotubes. The two longest dimensions of the graphene sheets can each be at least about 10 times greater, or at least about 50 times greater, or at least about 100 times greater, or at least about 1000 times greater, or at least about 5000 times greater, or at least about 10,000 times greater than the shortest dimension (i.e. thickness) of the sheets. Graphene sheets are distinct from expanded, exfoliated, vermicular, etc. graphite, which has a layered or stacked structure in which the layers are not separated from each other. The graphene sheets do not need to be entirely made up of carbon, but can have heteroatoms incorporated into the lattice or as part of functional groups attached to the lattice. The lattice need not be a perfect hexagonal lattice and can contain defects (including five-and seven-membered rings).

Graphene sheets can be made using any suitable method. For example, they can be obtained from graphite, graphite oxide, expandable graphite, expanded graphite, etc. They can be obtained by the physical exfoliation of graphite, by for example, peeling, grinding, milling, graphene sheets. They made be made by sonication of precursors such as graphite. They can be made by opening carbon nanotubes. They can be made from inorganic precursors, such as silicon carbide. They can be made by chemical vapor deposition (such as by reacting a methane and hydrogen on a metal surface). They can be made by epitaxial growth on substrates such as silicon carbide and metal substrates and by growth from metal-carbon melts. They made by made

They can be made by the reduction of an alcohol, such ethanol, with a metal (such as an alkali metal like sodium) and the subsequent pyrolysis of the alkoxide product (such a method is reported in Nature Nanotechnology (2009), 4, 30-33). They can be made from small molecule precursors such as carbon dioxide, alcohols (such as ethanol, methanol, etc.), alkoxides (such as ethoxides, methoxides, etc., including sodium, potassium, and other alkoxides). They can be made by the exfoliation of graphite in dispersions or exfoliation of graphite oxide in dispersions and the subsequently reducing the exfoliated graphite oxide. Graphene sheets can be made by the exfoliation of expandable graphite, followed by intercalation, and ultrasonication or other means of separating the intercalated sheets (see, for example, Nature Nanotechnology (2008), 3, 538-542). They can be made by the intercalation of graphite and the subsequent exfoliation of the product in suspension, thermally, etc. Exfoliation processes can be thermal, and include exfoliation by rapid heating, using microwaves, furnaces, hot baths, etc.

Graphene sheets can be made from graphite oxide (also known as graphitic acid or graphene oxide). Graphite can be treated with oxidizing and/or intercalating agents and exfoliated. Graphite can also be treated with intercalating agents and electrochemically oxidized and exfoliated. Graphene sheets can be formed by ultrasonically exfoliating suspensions of graphite and/or graphite oxide in a liquid (which can contain surfactants and/or intercalants). Exfoliated graphite oxide dispersions or suspensions can be subsequently reduced to graphene sheets. Graphene sheets can also be formed by mechanical treatment (such as grinding or milling) to exfoliate graphite or graphite oxide (which would subsequently be reduced to graphene sheets).

Reduction of graphite oxide to graphene can be by means of chemical reduction and can be carried out on graphite oxide in a dry form, in a dispersion, etc. Examples of useful chemical reducing agents include, but are not limited to, hydrazines (such as hydrazine, N,N-dimethylhydrazine, etc.), sodium borohydride, citric acid, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets.

Graphite oxide can be produced by any method known in the art, such as by a process that involves oxidation of graphite using one or more chemical oxidizing agents and, optionally, intercalating agents such as sulfuric acid. Examples of oxidizing agents include nitric acid, nitrates (such as sodium and potassium nitrates), perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite can also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in U.S. 2007/0092432, the disclosure of which is hereby incorporated herein by reference. The thusly formed graphene sheets can display little or no signature corresponding to graphite or graphite oxide in their X-ray diffraction pattern.

The thermal exfoliation can be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating can be done using a flash lamp or with microwaves. During heating, the graphite oxide can be contained in an essentially constant location in single batch reaction vessel, or can be transported through one or more vessels during the reaction in a continuous or batch mode. Heating can be done using any suitable means, including the use of furnaces and infrared heaters. Examples of temperatures at which the thermal exfoliation and/or reduction of graphite oxide can be carried out are at least about 150° C., at least about 200° C., at least about 300° C., at least about 400° C., at least about 450° C., at least about 500° C., at least about 600° C., at least about 700° C., at least about 750° C., at least about 800 ° C., at least about 850° C., at least about 900° C., at least about 950° C., at least about 1000° C., at least about 1100° C., at least about 1500° C., at least about 2000° C., and at least about 2500° C. Preferred ranges include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature can vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets can be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used can be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature can vary within these ranges.

The heating can be done under a variety of conditions, including in an inert atmosphere (such as argon or nitrogen) or a reducing atmosphere, such as hydrogen (including hydrogen diluted in an inert gas such as argon or nitrogen), or under vacuum. The heating can be done in any appropriate vessel, such as a fused silica or a mineral or ceramic vessel or a metal vessel. The materials being heated including any starting materials and any products or intermediates) can be contained in an essentially constant location in single batch reaction vessel, or can be transported through one or more vessels during the reaction in a continuous or batch reaction. Heating can be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area can be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets can have a bulk density of from about 0.01 to at least about 200 kg/m³. The bulk density includes all values and subvalues therebetween, especially including 0.05, 0.1, 0.5, 1, 5, 10, 15, 20, 25, 30, 35, 50, 75, 100, 125, 150, and 175 kg/m³.

The graphene sheets can be functionalized with, for example, oxygen-containing functional groups (including, for example, hydroxyl, carboxyl, and epoxy groups) and typically have an overall carbon to oxygen molar ratio (C/O ratio), as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1;

about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets can contain atomic scale kinks. These kinks can be caused by the presence of lattice defects in, or by chemical functionalization of the two-dimensional hexagonal lattice structure of the graphite basal plane.

The compositions can include graphite. Graphite can include, but is not limited to, natural, Kish, and synthetic, annealed, pyrolytic, highly oriented pyrolytic, etc. graphites.

When used, in some cases, the graphite can be present in from about 1 to about 99 percent, or from about 10 to about 99 percent, or from about 20 to about 99 percent, from about 30 to about 99 percent, or from about 40 to about 99 percent, or from about 50 to about 99 percent, or from about 60 to about 99 percent, or from about 70 to about 99 percent, or from about 80 to about 99 percent, or from about 85 to about 99 percent, or from about 90 to about 99 percent, or from about 1 to about 95 percent, or from about 10 to about 95 percent, or from about 20 to about 95 percent, from about 30 to about 95 percent, or from about 40 to about 95 percent, or from about 50 to about 95 percent, or from about 60 to about 95 percent, or from about 70 to about 95 percent, or from about 80 to about 95 percent, or from about 85 to about 95 percent, or from about 90 to about 95 percent, or from about 1 to about 80 percent, or from about 10 to about 80 percent, or from about 20 to about 80 percent, from about 30 to about 80 percent, or from about 40 to about 80 percent, or from about 50 to about 80 percent, or from about 60 to about 80 percent, or from about 70 to about 80 percent, or from about 1 to about 70 percent, or from about 10 to about 70 percent, or from about 20 to about 70 percent, from about 30 to about 70 percent, or from about 40 to about 70 percent, or from about 50 to about 70 percent, or from about 60 to about 70 percent, or from about 1 to about 60 percent, or from about 10 to about 60 percent, or from about 20 to about 60 percent, from about 30 to about 60 percent, or from about 40 to about 60 percent, or from about 50 to about 60 percent, or from about 1 to about 50 percent, or from about 10 to about 50 percent, or from about 20 to about 50 percent, from about 30 to about 50 percent, or from about 40 to about 50 percent, or from about 1 to about 40 percent, or from about 10 to about 40 percent, or from about 20 to about 40 percent, from about 30 to about 40 percent, from about 1 to about 30 percent, or from about 10 to about 30 percent, or from about 20 to about 30 percent, or from about 1 to about 20 percent, or from about 10 to about 20 percent, or from about 1 to about 10 percent, based on the total weight of graphene sheets and graphite.

The composition can be formed by blending (such as by grinding, milling, etc.) together the graphene sheets, cyclic compounds, and, optionally, graphite and/or other additives using any suitable dispersion method, including wet or dry methods and batch, semi-continuous, and continuous methods including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills, etc.)—Suitable materials for use as grinding media include metals, carbon steel, stainless steel, ceramics, stabilized ceramic media (such as cerium yttrium stabilized zirconium oxide), PTFE, glass, tungsten carbide, etc. Examples of grinding methods include ball milling, attriting, crushing, etc. and equipment such as ball mills, attrition equipment, sandmills, high pressure homogenizers, horizontal and vertical grinding mills (such as wet grinding mills), etc. The blending process can be done at any appropriate temperature and/or under pressure.

Two or more methods can be used, for example sequentially, or separate blends of graphene sheets, cyclic compounds, and optionally, other components can be made and later combined (including by using one of the above methods), etc.

Methods such as these can be used to change the particle size and/or morphology of graphene sheets, graphene sheets, other components, and blends or two or more components. They can intimately mix the graphene sheets, cyclic compounds, and optional components such as graphite.

Components can be processed together or separately and can go through multiple processing (including mixing/blending) stages, each involving one or more components (including blends).

There is no particular limitation to the way in which the graphene sheets, graphite (if used), the cyclic compounds, and other components are processed and combined. For example, graphene sheets and/or graphite can be processed into given particle size distributions and/or morphologies separately and then combined for further processing with or without the presence of additional components. Unprocessed graphene sheets and/or graphite can be combined with processed graphene sheets and/or graphite and further processed with or without the presence of additional components. Processed and/or unprocessed graphene sheets and/or processed and/or unprocessed graphite can be combined with other components, such as one or more binders and then combined with processed and/or unprocessed graphene sheets and/or processed and/or unprocessed graphite. Two or more combinations of processed and/or unprocessed graphene sheets and/or processed and/or unprocessed graphite that have been combined with other components can be further combined or processed. Any of the foregoing processing steps can be done in the presence of at least one cyclic compound.

Examples of solvents in which the graphene sheets, one or more cyclic compounds, and other components can be blended include one or more of water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF), dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, cumene, etc.), petroleum distillates, naphthas (such as VM&P naphtha), and mixtures of two or more of the foregoing and mixtures of one or more of the foregoing with other carriers. Solvents can be low- or non-VOC solvents, non-hazardous air pollution solvents, and non-halogenated solvents.

In some cases, the cyclic compounds are insoluble or sparingly soluble in the grinding solvent at the concentration in which the grinding occurs. For example, the cyclic compounds can have a solubility of less than about 40%, of less than about 30%, of less than about 20%, of less than about 15%, of less than about 10%, or less than about 5%, or less than about 3% or less than about 1%, or less than about 0.5%, or less than about 0.1 percent, or less than about 0.05%, or less than about 0.01%, or less than about 0.001%, based on the weight of the cyclic compound(s) and grinding solvent.

Examples of additives include dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, conductive additives, acids, functionalized aromatic compounds, etc.

Additives can be added to the compositions while they are being made, or after they are made. They can, for example, be included during the mixing/dispersing/grinding steps, added later directly to the composition, while the composition is formed into materials, etc.

Examples of dispersing aids include glycol ethers (such as poly(ethylene oxide), block copolymers derived from ethylene oxide and propylene oxide (such as those sold under the trade name Pluronic® by BASF), acetylenic diols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes.

Examples of grinding aids include stearates (such as Al, Ca, Mg, and Zn stearates) and acetylenic diols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec.

The compositions can optionally comprise at least one “multi-chain lipid”, by which term is meant a naturally-occurring or synthetic lipid having a polar head group and at least two nonpolar tail groups connected thereto. Examples of polar head groups include oxygen-, sulfur-, and halogen-containing, phosphates, amides, ammonium groups, amino acids (including a-amino acids), saccharides, polysaccharides, esters (Including glyceryl esters), zwitterionic groups, etc.

The tail groups can be the same or different. Examples of tail groups include alkanes, alkenes, alkynes, aromatic compounds, etc. They can be hydrocarbons, functionalized hydrocarbons, etc. The tail groups can be saturated or unsaturated.

They can be linear or branched. The tail groups can be derived from fatty acids, such as oleic acid, palmitic acid, stearic acid, arachidic acid, erucic acid, arachadonic acid, linoleic acid, linolenic acid, oleic acid, etc.

Examples of multi-chain lipids include, but are not limited to, lecithin and other phospholipids (such as phosphatidylcholine, phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; sphingolipids (such as ceramides, di- and triglycerides, phosphosphingolipids, and glycosphingolipids); etc. They can be amphoteric, including zwitterionic.

Examples of thickening agents include glycol ethers (such as poly(ethylene oxide), block copolymers derived from ethylene oxide and propylene oxide (such as those sold under the trade name Pluronic® by BASF), long-chain carboxylate salts (such aluminum, calcium, zinc, etc. salts of stearates, oleats, palmitates, etc.), aluminosilicates (such as those sold under the Minex® name by Unimin Specialty Minerals and Aerosil® 9200 by Evonik Degussa), fumed silica, natural and synthetic zeolites, etc.

Compositions can contain electrically and/or thermally conductive components, such as metals (including pure metals and metal alloys), conductive metal oxides, conductive carbons, polymers, metal-coated materials, etc. These components can take a variety of forms, including particles, powders, flakes, foils, needles, etc.

Examples of metals include, but are not limited to silver, copper, aluminum, platinum, palladium, nickel, chromium, gold, zinc, tin, iron, gold, lead, steel, stainless steel, rhodium, titanium, tungsten, magnesium, brass, bronze, colloidal metals, etc. Examples of metal oxides include antimony tin oxide and indium tin oxide and materials such as fillers coated with metal oxides. Metal and metal-oxide coated materials include, but are not limited to metal coated carbon and graphite fibers, metal coated glass fibers, metal coated glass beads, metal coated ceramic materials (such as beads), etc. These materials can be coated with a variety of metals, including nickel.

Examples of thermally conductive additives include metal oxides, nitrides, ceramics, minerals, silicates, etc. Examples include boron nitride, aluminum nitride, alumina, aluminum nitride, berylium oxide, nickel oxide, titanium dioxide, copper(I) oxide, copper (II) oxide, iron(II) oxide, iron(I,II) oxide (magnetite), iron (III) oxide, silicon dioxide, zinc oxide, magnesium oxide (MgO), etc.

Examples of electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polydiaminonathphalene, polyisonaphthalene, polyaniline, polypyrrole, poly(phenylene sulfide), polycarbozoles, polyindoles, polyphenylenes, copolymers of one or more of the foregoing, etc., and their derivatives and copolymers. The conductive polymers can be doped or undoped. They can be doped with boron, phosphorous, iodine, etc.

Examples of conductive carbons include, but are not limited to, graphite (including natural, Kish, and synthetic, annealed, pyrolytic, highly oriented pyrolytic, etc. graphites), graphitized carbon, mesoporous carbon, carbon black, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, etc.

The compositions can further comprise one or more acid catalysts. The acids can be organic acids or mineral acids. The pKa in water of the acid is preferably less than about 4, or more preferably less than about 3, or yet more preferably less than about 2.5. The pKa in water can be less than about 2, or less than about 1, or less than about 0. The acids can be in a blocked form. In such cases, the pKa is based on the unblocked acid. The acid can be a curing catalyst.

Examples of mineral acids include sulfuric acid, hydrochloric acid, nitric acid, nitrous acid, phosphoric acid, boric acid, hydrobromic acid, perchloric acid, etc. Examples of acids include sulfur-based acids such as sulfonic acids, polysulfonic acids (such as disulfonic acids), sulfinic acids, including monomeric and polymeric organic sulfonic acids such as aromatic sulfonic acids such as benzenesulfonic acids, alkylbenzene sulfonic acids, alkyl and aliphatic sulfonic acids, toluenesulfonic acids, and naphthalenesulfonic acids. Examples of sulfonic acids include p-toluenesulfonic acid, benzenesulfonic acid, cresol sulfonic acid, 4-ethylbenzenesulfonic acid, xylenesulfonic acid, dimethylbenzenesulfonic acid, phenolsulfonic acid, dinonylnaphthalenesulfonic acid (DNNSA), dinonylnaphthalenedisulfonic acid (DNNDSA), dodecylbenzenesulfonic acid (DDBSA), methanesulfonic acid, etc. Examples also include sulfonic acid resins such as poly(stryenesulfonic acid), sulfonated fluoropolymers (such as sulfonated tetrafluoroethylene (e.g., Nafion®)), etc.

The acids can be phosphorous-based acids, such as phosphoric acid and its derivatives, phosphorous acid and its derivatives, organic phosphorous and phosphate-based acids, such as alkyl and dialkyl acid phosphates, etc. Examples include amyl acid phosphate, diamyl acid phosphate, butyl acid phosphate, dibutyl acid phosphate, ethyl acid phosphate, diethyl acid phosphate, octyl acid phosphate, dioctyl acid phosphate, etc. They can be metal salts of phosphorous-based acids, such as metal salts of phosphoric acid and phosphoric acid esters.

In some cases, the acids can be present in from about 1 to about 99 percent, or from about 10 to about 99 percent, or from about 20 to about 99 percent, from about 30 to about 99 percent, or from about 40 to about 99 percent, or from about 50 to about 99 percent, or from about 60 to about 99 percent, or from about 70 to about 99 percent, or from about 80 to about 99 percent, or from about 85 to about 99 percent, or from about 90 to about 99 percent, or from about 1 to about 95 percent, or from about 10 to about 95 percent, or from about 20 to about 95 percent, from about 30 to about 95 percent, or from about 40 to about 95 percent, or from about 50 to about 95 percent, or from about 60 to about 95 percent, or from about 70 to about 95 percent, or from about 80 to about 95 percent, or from about 85 to about 95 percent, or from about 90 to about 95 percent, or from about 1 to about 80 percent, or from about 10 to about 80 percent, or from about 20 to about 80 percent, from about 30 to about 80 percent, or from about 40 to about 80 percent, or from about 50 to about 80 percent, or from about 60 to about 80 percent, or from about 70 to about 80 percent, or from about 1 to about 70 percent, or from about 10 to about 70 percent, or from about 20 to about 70 percent, from about 30 to about 70 percent, or from about 40 to about 70 percent, or from about 50 to about 70 percent, or from about 60 to about 70 percent, or from about 1 to about 60 percent, or from about 10 to about 60 percent, or from about 20 to about 60 percent, from about 30 to about 60 percent, or from about 40 to about 60 percent, or from about 50 to about 60 percent, or from about 1 to about 50 percent, or from about 10 to about 50 percent, or from about 20 to about 50 percent, from about 30 to about 50 percent, or from about 40 to about 50 percent, or from about 1 to about 40 percent, or from about 10 to about 40 percent, or from about 20 to about 40 percent, from about 30 to about 40 percent, from about 1 to about 30 percent, or from about 10 to about 30 percent, or from about 20 to about 30 percent, or from about 1 to about 20 percent, or from about 10 to about 20 percent, or from about 1 to about 10 percent, based on the total weight of acids and graphene sheets plus graphite, if present.

The functionalized aromatic compounds are substituted with one, two, or more functional groups. The functional groups are preferably nucleophilic or electrophilic. In some cases, they are capable of reacting with hydroxyl groups, carboxylic acids or carboxylic acid derivates, and/or epoxy groups. Examples of functional groups include, but are not limited to, hydroxyls, hydroperoxy and peroxy groups, carboxylic acids, carboxylic acid salts (e.g. Li, Na, K, Mg, Ca, Zn, etc. salts), esters, anhydrides, acid halides (including acid chlorides), aldehydes (e.g. formyl groups), acetals, orthoesters, carbonates, amino groups, amides, imines, imides, azides, cyanates, isocyanates, thiol groups, sulfo, sulfino, thiocyanates, expoxies, ethers, etc. In some cases, there are one, two, three, four, or more functional groups in the functionalized aromatic compound. The functionalized aromatic compounds are distinct from the cyclic compound.

Examples of functionalized aromatic compounds include benozoic acid and benzoic acid derivatives, hydroxybenzoic acids (including 4-hydroxybenzoic acid), hydroxybenzaldehydes (including 4-hydroxybenzaldehyde), formyl benzoic acids (including 4-formyl benzoic acid), terephthaldehyde, isophthaldehyde, phthaldialdehyde, terephthalic acid (and esters such as methyl terephthalate, dimethyl terephthalate, etc.), isophthalic acid (and esters such as methyl isophthalate, dimethyl isophthalate, etc.), phthalic acid (and esters such as methyl phthalate, dimethyl phthalate, etc.), phthalic anhydride, bisphenols (such as bisphenol A), biphenyl, 4,4′-biphenol, 3,3′-biphenol, 2,2′-biphenol, 4-hydroxybiphenyl, 3-hydroxybiphenyl, 2-hydroxybiphenyl, naphthalene, hydroxynaphthalenes, dihydroxynaphthalenes (including 2,6-dihydroxynaphthalene, 1,5-dihydroxynaphthalene, 2,3-dihydroxynaphthalene, 1,7-dihydroxynaphthalene, 1,4-dihydroxynaphthalene, 1,2-dihydroxynaphthalene, 1,3-dihydroxynaphthalene, 2,7-dihydroxynaphthalene, and 1,6-dihydroxynaphthalene), naphthalenecarboxylic acids, naphthalenecarboxylic acid esters, naphthalenedicarboxylic acids, naphthalenedicarboxylic acid esters, anthracene, pyrene, pentacene phenol, hydroquinone, catechol, resorcinol, etc.

In some cases, the functionalized aromatic compounds can be present in from about 1 to about 99 percent, or from about 10 to about 99 percent, or from about 20 to about 99 percent, from about 30 to about 99 percent, or from about 40 to about 99 percent, or from about 50 to about 99 percent, or from about 60 to about 99 percent, or from about 70 to about 99 percent, or from about 80 to about 99 percent, or from about 85 to about 99 percent, or from about 90 to about 99 percent, or from about 1 to about 95 percent, or from about 10 to about 95 percent, or from about 20 to about 95 percent, from about 30 to about 95 percent, or from about 40 to about 95 percent, or from about 50 to about 95 percent, or from about 60 to about 95 percent, or from about 70 to about 95 percent, or from about 80 to about 95 percent, or from about 85 to about 95 percent, or from about 90 to about 95 percent, or from about 1 to about 80 percent, or from about 10 to about 80 percent, or from about 20 to about 80 percent, from about 30 to about 80 percent, or from about 40 to about 80 percent, or from about 50 to about 80 percent, or from about 60 to about 80 percent, or from about 70 to about 80 percent, or from about 1 to about 70 percent, or from about 10 to about 70 percent, or from about 20 to about 70 percent, from about 30 to about 70 percent, or from about 40 to about 70 percent, or from about 50 to about 70 percent, or from about 60 to about 70 percent, or from about 1 to about 60 percent, or from about 10 to about 60 percent, or from about 20 to about 60 percent, from about 30 to about 60 percent, or from about 40 to about 60 percent, or from about 50 to about 60 percent, or from about 1 to about 50 percent, or from about 10 to about 50 percent, or from about 20 to about 50 percent, from about 30 to about 50 percent, or from about 40 to about 50 percent, or from about 1 to about 40 percent, or from about 10 to about 40 percent, or from about 20 to about 40 percent, from about 30 to about 40 percent, from about 1 to about 30 percent, or from about 10 to about 30 percent, or from about 20 to about 30 percent, or from about 1 to about 20 percent, or from about 10 to about 20 percent, or from about 1 to about 10 percent, based on the total weight of the functionalized aromatic compound and graphene sheets plus graphite, if used.

In some cases, the functionalized aromatic compounds can react with the graphene sheets and/or any polymeric binder or matrix that is present. In these cases, the aromatic compound can serve to crosslink the graphene sheets to itself and/or to the binder and/or crosslink the polymeric binder to itself. The formulations can have improved electrical conductivity and mechanical properties (such as improved adhesion when formed into inks or coatings and printed).

When the compositions are made in the presence of a solvent, the solvent may be removed in whole or in part (such as by evaporation, filtration, solvent exchange, etc.) prior to using the compositions. The compositions can be combined with polymers and/or more or more additives (such as those described above) to make other materials, such as composites (including polymer composites), inks and coatings, etc. One or more polymers can be added during the blending step to make the compositions. They can be used in thermal transfer applications. They can be used in electrodes, such as those used in solar cells (including dye-sensitized solar cells, organic solar cells, etc.), light-emitting diodes, batteries (such as electrodes for use in rechargeable, lithium ion, lithium polymer, lithium air, etc. batteries), capacitors (including ultracapacitors), etc. Polymer composites can be used in gas barrier applications. Rubber composites can be used in tire applications. The compositions can be in the form of adhesives. They can be used to make sensors.

The compositions can be combined with polymers using any suitable method, including melt processing (using, for example, a single or twin-screw extruder, a blender, a kneader, a Banbury mixer, etc.) and solution/dispersion blending. The polymers can be used as binders. When used, the polymers can be thermosets, thermoplastics, non-melt processible polymers, etc. Polymers can also comprise monomers and/or oligomers that can be polymerized before, during, or after the application of the coating to the substrate. The compositions can be blended with rubbers and other elastomers in a mixer and the rubber or elastomer blends later crosslinked.

Articles can be formed from composites using any suitable method, including compression molding, extrusion, ram extrusion, injection molding, extrusion, co-extrusion, rotational molding, blow molding, injection blow molding, flexible molding, thermoforming, vacuum forming, casting, solution casting, centrifugal casting, overmolding, reaction injection molding, vacuum assisted resin transfer molding, spinning, printing, spraying, sputtering, coating, roll-to-roll processing, laminating, etc. Thermoset articles can be formed by mixing resin precursors with the compositions and, optionally, other additives in a mold and curing to form the article.

The compositions can be in the form of inks and coatings. By the terms “ink” and “coating” are meant compositions that are in a form that is suitable for application to a substrate as well as the material after it is applied to the substrate, while it is being applied to the substrate, and both before and after any post-application treatments (such as evaporation, cross-linking, curing, etc.). The components of the ink and coating compositions can vary during these stages. The inks and coatings can optionally further comprise a polymeric binder.

In some cases, when one or more polymers are used in the composition, they can be present relative to the graphene sheets and graphite, if present, in from about 1 to about 99 weight percent, or from about 1 to about 50 weight percent, or from about 1 to about 30 weight percent, or from about 1 to about 20 weight percent, or from about 5 to about 80 weight percent, or from about 5 to about 60 weight percent, or from about 5 to about 30 weight percent, or from about 15 to about 85 weight percent, or from about 15 to about 60 weight percent, or from about 15 to about 30 weight percent, or from about 25 to about 80 weight percent, or from about 25 to about 50 weight percent, or from about 40 to about 90 weight percent, or from about 50 to about 90 weight percent, or from about 70 to about 95 weight percent, based on the total weight of binder and graphene sheets and graphite if present.

Examples of polymers useful as binders or for incorporating into the compositions include polyolefins, such as polyethylene, low density polyethylene (LDPE), linear low density polyethylene (LLDPE), high density polyethylene, ultrahigh molecular weight polyethylene, polypropylene, olefin polymers and copolymers, ethylene/propylene copolymers (EPR), ethylene/propylene/diene monomer copolymers (EPDM); olefin and styrene copolymers; polystyrene (including high impact polystyrene); styrene/butadiene rubbers (SBR); styrene/ethylene/butadiene/styrene copolymers (SEBS); isobutylene/maleic anhydride copolymers; ethylene/acrylic acid copolymers; acrylonitrile/butadiene/styrene copolymers (ABS); styrene/acrylonitrile polymers (SAN); styrene/maleic anhydride copolymers; poly(acrylonitrile); polyethylene/acrylonitrile butadiene styrene (PE/ABS), polyvinyl pyrrolidone) and polyvinyl pyrrolidone) copolymers; vinyl acetate/vinyl pyrrolidone copolymers; polyvinyl acetate); polyvinyl acetate) copolymers; ethylene/vinyl acetate copolymers (EVA); polyvinyl alcohols) (PVOH); ethylene/vinyl alcohol copolymers (EVOH); polyvinyl butyral) (PVB); polyvinyl formal), polycarbonates (PC); polycarbonate/acrylonitrile butadiene styrene copolymers (PC/ABS); polyamides; polyesters; liquid crystalline polymers (LCPs); poly(lactic acid) (PLA); poly(phenylene oxide) (PPO); PPO-polyamide alloys; polysulphones (PSU); polysulfides; poly(phenylene sulfide); polyetherketone (PEK); polyetheretherketone (PEEK); cross-linked polyetheretherketone (XPEEK); polyimides; polyoxymethylene (POM) homo- and copolymers (also called polyacetals); polyetherimides; polyphenylene (self-reinforced polyphenylene (SRP); polybenimidazole (PBI), aramides (such as Kevlar® and Nomex®); polyureas; alkyds; cellulosic polymers (such as nitrocellulose, ethyl cellulose, ethyl hydroxyethyl cellulose, carboxymethyl cellulose, cellulose acetate, cellulose acetate propionates, and cellulose acetate butyrates); polyethers (such as poly(ethylene oxide), poly(propylene oxide), poly(propylene glycol), oxide/propylene oxide copolymers, etc.); alkyds; acrylic latex polymers; polyester acrylate oligomers and polymers; polyester diol diacrylate polymers; phenolic resins; melamine formaldehyde resins; urea formaldehyde resins; novolacs; polyvinyl chloride); poly(vinylidene chloride); fluoropolymers (such as polytetrafluoroethylene (PTFE), fluorinated ethylene propylene polymers (FEP), polyvinyl fluoride), poly(vinylidene fluoride), vinylidene fluoride/hexafluoropropylene copolymers (VF2/HFP), vinylidene fluoride/hexafluoropropylene/tetrafluoroethylene (VF2/HFP/TFE) copolymers, vinylidene fluoride)/vinyl methyl ether/tetrafluoroethylene (VF2/PVME/TFE) copolymers, vinylidene fluoride/hexafluoropropylene/tetrafluoroethylene copolymers (VF2/HPF/TFE), vinylidene fluoride/tetrafluoroethylene/propylene (VF2/TFE/P) copolymers, perfluoroelastomers such as tetrafluoroethylene perfluoroelastomers (FFKM), highly fluorinated elastomers (FEPM), perfluoro(alkyl vinyl ethers), perfluoro(methyl vinyl ether) (PMVE), perfluoro(ethyl vinyl ether) (PEVE), perfluoro(propyl vinyl ether) (PPVE), fluoropolymers having one or more repeat units derived from vinylidene fluoride, hexafluoropropylene, tetrafluoroethylene, chlorotrifluoroethylene (CTFE), perfluoro(alkyl vinyl ethers), etc.); polysiloxanes (e.g., (polydimethylenesiloxane, dimethylsiloxane/vinylmethylsiloxane copolymers, vinyldimethylsiloxane terminated poly(dimethylsiloxane), etc.); polyurethanes (thermoplastic and thermosetting (including crosslinked polyurethanes such as those crosslinked amines, etc.); epoxy polymers (including crosslinked epoxy polymers such as those crosslinked with polysulfones, amines, etc.); acrylate polymers (such as poly(methyl methacrylate), acrylate polymers and copolymers, methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates, etc.), etc.

Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD, 6)) and polyterephthalamides such as poly(dodecamethylene terephthalamide) (polyamide 12, T), poly(decamethylene terephthalamide) (polyamide 10, T), poly(nonamethylene terephthalamide) (polyamide 9, T), the polyamide of hexamethylene terephthalamide and hexamethylene adipamide, the polyamide of hexamethyleneterephthalamide, and 2-methylpentamethyleneterephthalamide), etc. The polyamides can be polymers and copolymers (i.e., polyamides having at least two different repeat units) having melting points between about 120 and 255° C. including aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, etc. Examples of these include those sold under the trade names Macromelt by Henkel and Versamid by Cognis.

Examples of acrylate polymers include those made by the polymerization of one or more acrylic acids (including acrylic acid, methacrylic acid, etc.) and their derivatives, such as esters. Examples include methyl acrylate polymers, methyl methacrylate polymers, and methacrylate copolymers. Examples include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers can comprise repeat units derived from other monomers such as olefins (e.g. ethylene, propylene, etc.), vinyl acetates, vinyl alcohols, vinyl pyrrolidones, etc. They can include partially neutralized acrylate polymers and copolymers (such as ionomer resins).

Examples of polymers include Elvacite® polymers supplied by Lucite International, Inc., including Elvacite® 2009, 2010, 2013, 2014, 2016, 2028, 2042, 2045, 2046, 2550, 2552,2614, 2669, 2697, 2776, 2823, 2895, 2927, 3001, 3003, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682).

Examples of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT)), etc.

Examples of rubbers and elastomers include styrene/butadiene copolymers (SBR), styrene/ethylene/butadiene/styrene copolymer (SEBS), polyisoprene, ethylene/propylene copolymers (EPR), ethylene/propylene/monomer copolymers (EPM), ethylene/propylene/diene monomer copolymers (EPDM), chlorosulphonated polyethylene (CSM), chlorinated polyethylene (CM), ethylene/vinyl acetate copolymers (EVM), butyl rubber, natural rubber, polybutadiene (Buna CB), chloroprene rubber (CR), halogenated butyl rubber, bromobutyl rubber, chlorobutyl rubber, nitrile rubber (butadiene/acrylonitrile copolymer) (NBR) (Buna N rubber), hydrogenated nitrile rubber (HNBR), carboxylated high-acrylonitrile butadiene rubbers (XNBR), carboxylated HNBR, epichlorohydrin copolymers (ECO), epichlorohydrin terpolymers (GECO), polyacrylic rubber (ACM, ABR), ethylene/acrylate rubber (AEM), polynorbornenes, polysulfide rubbers (e.g. OT and EOT), copolyetheresters, ionomers, polyurethanes, polyether urethanes, polyester urethanes, silicone rubbers and elastomers (such as polysiloxanes (e.g., (polydimethylenesiloxane, dimethylsiloxane/vinylmethylsiloxane copolymers, vinyldimethylsiloxane terminated poly(dimethylsiloxane), etc.), fluorosilicone rubber, fluoromethyl silicone rubber (FMQ), fluorovinyl silicone rubbers (FVMQ), phenylmethyl silicone rubbers (PMQ), vinyl silicone rubbers, etc.), fluoropolymers (such as perfluorocarbon rubbers (FFKM), fluoronated hydrocarbon rubbers (FKM), fluorinated ethylene propylene polymers (FEP), polyvinyl fluoride), poly(vinylidene fluoride), vinylidene fluoride/hexafluoropropylene copolymers (VF2/H FP), vinylidene fluoride/hexafluoropropylene/tetrafluoroethylene (VF2/HFP/TFE) copolymers, vinylidene fluoride)/vinyl methyl ether/tetrafluoroethylene (VF2/PVME/TFE) copolymers, vinylidene fluoride/hexafluoropropylene/tetrafluoroethylene copolymers (VF2/HPF/TFE), vinylidene fluoride/tetrafluoroethylene/propylene (VF2/TFE/P) copolymers, perfluoroelastomers such as tetrafluoroethylene perfluoroelastomers (FFKM), highly fluorinated elastomers (FEPM), perfluoro(alkyl vinyl ethers), perfluoro(methyl vinyl ether) (PMVE), perfluoro(ethyl vinyl ether) (PEVE), perfluoro(propyl vinyl ether) (PPVE), fluoropolymers having one or more repeat units derived from vinylidene fluoride, hexafluoropropylene, tetrafluoroethylene, chlorotrifluoroethylene (CTFE), perfluoro(alkyl vinyl ethers), etc.), and the like.

Inks and coatings can be formed from the compositions. One or more additional components such as solvents (such as one or more of these described above), binders (such as those described above), additives (such as those described above), graphene sheets and/or graphite that have not been blended with the cyclic compound, etc. can be combined with the compositions to form inks and coatings.

Inks and coatings can be applied to a wide variety of substrates, including, but not limited to, rigid materials, flexible and/or stretchable materials, silicones and other elastomers and other polymeric materials, metals (such as aluminum, copper, steel, stainless steel, etc.), adhesives, heat-sealable materials (such as cellulose, biaxially oriented polypropylene (BOPP), poly(lactic acid), polyurethanes, etc.), fabrics (including cloths) and textiles (such as cotton, wool, polyesters, rayon, etc.), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials, etc. Substrates can in the form of films, papers, wafers, larger three-dimensional objects, etc.

The substrates can have been treated with other coatings (such as paints) or similar materials before the inks and coatings are applied. Examples include substrates (such as PET) coated with indium tin oxide, antimony tin oxide, etc. They can be woven, nonwoven, in mesh form; etc. They can be woven, nonwoven, in mesh form; etc. The substrates can be paper-based materials generally (including paper, paperboard, cardboard, glassine, etc.). Paper-based materials can be surface treated. Examples of surface treatments include coatings such as polymeric coatings, which can include PET, polyethylene, polypropylene, acetates, nitrocellulose, etc. Coatings can be adhesives. Paper based materials can be sized. Substrates can be leathers. Examples of leather include, but are not limited to full-grain, top-grain, corrected-grain, split, bonded, aniline, boiled, composition, corinthian, morocco, etc. leathers. The leather can be hides, skins, buckskin, patent leather, brained leather, fish leather, vachetta leather, deerskin, nubuck, Russia leather, belting leather, napa leather, reconstituted leather, bycast leather, etc. The leather can come from cattle, lambs, deer, elks, pigs, buffalos, goats, alligators, dogs, snakes, ostriches, kangaroos, oxen, yaks, snakes, crocodiles, ostrich, chamois, horses, donkeys, zebras, etc.

The leather can be artificial (also known as synthetic) leather (including bicast leather, Kirza, Pleather, Poromeric imitation leather, vegan leather, etc.).

Examples of polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid), etc).; polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), polyvinyl fluoride), poly(vinylidene fluoride), etc.); polyetherimides; polyvinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); Mylar; etc. They can be non-woven materials, such as DuPont Tyvek®. They can be adhesive or adhesive-backed materials (such as adhesive-backed papers or paper substitutes). They can be mineral-based paper substitutes such as Teslin® from PPG Industries. The substrate can be a transparent or translucent or optical material, such as glass, quartz, polymer (such as polycarbonate or poly(meth)acrylates (such as poly(methyl methacrylate).

Examples of printing or coating methods include, but are not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is hereby incorporated herein by reference), microprinting, pad printing, tampon printing, stencil printing, wire rod coating, drawing, flexographic printing, stamping, xerography, microcontact printing, dip pen nanolithography, laser printing, via pen or similar means, etc. The compositions can be applied in multiple layers. After they have been applied to a substrate, the inks and coatings can be cured using any suitable technique, including drying and oven-drying (in air or another inert or reactive atmosphere), UV curing, IR curing, drying, crosslinking, thermal curing, laser curing, IR curing, microwave curing or drying, sintering, and the like. Polymeric binders can be crosslinked or otherwise cured after the ink or coating has been applied to the substrate.

The cured inks and coatings can have a variety of thicknesses. For example, they can optionally have a thickness of at least about 2 nm, or at least about 5 nm. In various embodiments, the coatings can optionally have a thickness of about 2 nm to 2 mm, about 5 nm to 1 mm, about 2 nm to about 100 nm, about 2 nm to about 200 nm, about 2 nm to about 500 nm, about 2 nm to about 1 micrometer, about 5 nm to about 200 nm, about 5 nm to about 500 nm, about 5 nm to about 1 micrometer, about 5 nm to about 50 micrometers, about 5 nm to about 200 micrometers, about 10 nm to about 200 nm, about 50 nm to about 500 nm, about 50 nm to about 1 micrometer, about 100 nm to about 10 micrometers, about 1 micrometer to about 2 mm, about 1 micrometer to about 1 mm, about 1 micrometer to about 500 micrometers, about 1 micrometer to about 200 micrometers, about 1 micrometer to about 100 micrometers, about 50 micrometers to about 1 mm, about 100 micrometers to about 2 mm, about 100 micrometers to about 1 mm, about 100 micrometers to about 750 micrometers, about 100 micrometers to about 500 micrometers, about 500 micrometers to about 2 mm, or about 500 micrometers to about 1 mm.

When applied to a substrate, the inks and coatings can have a variety of forms and be articles or components thereof. They can be present as a film or lines, patterns, letters, numbers, circuitry, logos, identification tags, and other shapes and forms. The inks and coatings can be covered in whole or in part with additional material, such as overcoatings, varnishes, polymers, fabrics, etc.

The inks and coatings can be applied to the same substrate in varying thicknesses at different points and can be used to build up three-dimensional structures on the substrate.

The inks and coatings can be used for the passivation of surfaces, such as metal (e.g. steel, aluminum, etc.) surfaces, including exterior structures such as bridges and buildings. Examples of other uses of the inks and coatings include: UV radiation resistant coatings, abrasion resistant coatings, coatings having permeation resistance to liquids (such as hydrocarbon, alcohols, water, etc.) and/or gases, electrically conductive coatings, static dissipative coatings, and blast and impact resistant coatings. They can be used to make fabrics having electrical conductivity. The inks and coatings can be used in solar cell applications; solar energy capture applications; signage, flat panel displays; flexible displays, including light-emitting diode, organic light-emitting diode, and polymer light-emitting diode displays; backplanes and frontplanes for displays; and lighting, including electroluminescent and OLED lighting. The displays can be used as components of portable electronic devices, such as computers, cellular telephones, games, GPS receivers, personal digital assistants, music players, games, calculators, artificial “paper” and reading devices, etc.

The can be used to make heaters and batteries.

They can be used in packaging and/or to make labels. They can be used in inventory control and anti-counterfeiting applications (such as for pharmaceuticals), including package labels. They can be used to make smart packaging and labels (such as for marketing and advertisement, information gathering, inventory control, information display, etc.). They can be used to form a Faraday cage in packaging, such as for electronic components.

The inks and coatings can be used on electrical and electronic devices and components, such as housings etc., to provide EMI shielding properties. They made be used in microdevices (such as microelectromechanical systems (MEMS) devices) including to provide antistatic coatings.

They can be used in the manufacture of housings, antennas, and other components of portable electronic devices, such as computers, cellular telephones, games, navigation systems, personal digital assistants, music players, games, calculators, radios, artificial “paper” and reading devices, etc.

The inks and coatings can be used to form thermally conductive channels on substrates or to form membranes having desired flow properties and porosities. Such materials could have highly variable and tunable porosities and porosity gradients can be formed. The inks and coatings can be used to form articles having anisotropic thermal and/or electrical conductivities. The coatings can be used to form three-dimensional printed prototypes.

The inks and coatings can be used to make printed electronic devices (also referred to as “printed electronics) that can be in the form of complete devices, parts or sub elements of devices, electronic components, etc., including wearable electronic devices. Electronic devices can be used independently of other devices, to control one or more additional remote devices, and/or be controlled by one or more additional remote devices. Connection to the remote devices can be wireless or wired.

Printed electronics can be prepared by applying the inks and coatings to the substrate in a pattern comprising an electrically conductive pathway designed to achieve the desired electronic device. The pathway can be solid, mostly solid, in a liquid or gel form, etc.

Electronic devices can take on a wide variety of forms and be used in a large array of applications and articles. They can contain multiple layers of electronic components (e.g. circuits) and/or substrates. All or part of the printed layer(s) can be covered or coated with another material such as a cover coat, varnish, cover layer, cover films, dielectric coatings, electrolytes and other electrically conductive materials, etc. There can also be one or more materials between the substrate and printed circuits. Layers can include semiconductors, metal foils, dielectric materials, etc. Electronic devices can comprise one or more electronic, electrical, or other components, such as microprocessors, input devices, buttons, ports, adapters, controllers, displays, ports, data-exchange devices, wireless devices, antennas, accelerometers, speakers, microphones, cameras, headphone/microphone/speaker jacks, sensors, vibrators, haptic technology, keyboards, membrane switches, heat sinks, batteries, storage devices (such as hard drives, flash memory, solid state drives, memory cards, etc.), communications devices, modems, interface devices, lights or indicators (such as LED lights), digitizers, RFID readers, RFID transmitters, solar panels, music or media players, voice recognition devices and software, etc. Adapters can include USB adapters, Bluetooth adapters, wireless adapters, Wi-Fi adapters, cellular adapters, FireWire adapters, ethernet adapters, infrared adapters, etc.

Examples of displays include LCD and LED displays and touchscreens (including capacitive (including those based on surface capacitance, projected capacitance, mutual capacitance, self-capacitance, matrix approach, etc.), resistive, surface acoustic wave, infrared touch, optical imaging, dispersive signal technology, acoustic pulse recognition, etc. displays.

The electronic devices can be receivers, personal digital assistants, music, video, or other media players, games, calculators, reading devices, watches, etc. They can be controllers for or interact with GPS and navigation systems, computers, laptop computers, tablet computers, telephones, PDAs, electronic readers, video game systems and consoles, stereo systems, televisions, music players, video players, network devices, toys, robots, medical equipment, remote- or radio-controlled devices (such as cars, boats, airplanes helicopters, drones, etc.) including remote- or radio-controlled toys. They can be controllers for heating and cooling devices, thermostats, etc.

The devices can be used for medical, sports and exercise, military, first responder (such as firefighter, etc.), security, etc. applications. They can be used as barcode readers, smartcard readers, RFID tag readers, magnetic strip readers, etc.

The electronic devices can contain sensors or detectors, such as those that detect or sense temperature or heat, position, acceleration or speed, moisture, chemicals, smokes, gases (such as carbon dioxide, carbon monoxide, oxygen, etc.), pressure, etc.

The sensors can be used for medical, health, athletic, physiological, biometric, etc. applications, such as hydration sensors, biometric sensors, medical sensors, heart rate sensors, sweat sensors, glucose level sensors, vital signs sensors, oxygen-level sensors, body temperature sensors, moisture level sensors, breathing sensors, body fat sensors, bioimpedance sensors, etc.

The devices can have haptic capabilities, providing force feedback, vibration feedback, etc. Devices having hapatic capabilities can be used as controllers, such as video game controllers, controllers for remote- or radio-controlled devices, etc.

The devices can be used in addition or as a supplement to game controllers normally used with games (e.g., as a secondary controller). They can provide special input buttons. In some cases, special function input buttons could be specific to certain games (such as to provide special views, activate certain properties or powers, call in certain playing features (such as weapons, airplanes, vehicles, etc.), provide the ability to control extra or secondary characters, etc. For example, a device in the form of a wristband could be used to control a special character, such as one wearing a similar wristband.

In some cases (such as by means of an accelerometer), the electronic devices may be used to control other devices by motion. For example, if the apparel containing the electronic device is worn on an appendage such as arm, wrist, finger, leg, ankle, head, etc., by moving the appendage in different directions or at different speeds, the user can control other devices, such as radio controlled devices, stereo systems, video games, music players, etc.

Examples of components that can be printed include components for touchpads, displays, screens, input devices, touchpad surfaces and panels, x-y grids for capacitive devices, batteries, connectors, wires, dielectrics, resistors, backplanes and frontplanes for displays, antennas, chips, busbars, leads, wires, panels, circuits, transistors, electrodes, sensors, RFID components (e.g. tags, chips, antennas), switches, etc.

In some cases, one or more components can be flexed, bent, folded, creased, curled, rolled, crumpled, twisted, or otherwise distorted.

Examples of input devices can include touchpads (also referred to as trackpads), touch screens, keyboards, buttons, non-contact input devices, etc. Multitouch input devices, gesture recognition input devices, etc. can be used.

The electronic devices can be connected to or communicate with other devices using any suitable method or hardware (such as adapters). Connections can be wireless and/or wired. Methods include USB, FireWire, HDMI, ethernet, Wi-Fi, cellular, infrared (IR), near-field communication (NFC), radio frequency, RFID, parallel devices, serial devices, modems, etc.

The devices can be powered by AC or DC current, cells or batteries, USB connections, solar power, mains power, or any suitable method. Cells and batteries can be integrated into the device, kept in the vicinity of the device, or worn in a different part of the body from the device. Cells and batteries can be rechargeable, disposable, etc. They can be charged from solar panels. The cells and batteries can comprise coin cells.

The devices or components thereof can be attached to and/or integrated into the article of apparel. Devices can be attached and/or integrated into the article of apparel using any suitable means, such as by sewing, gluing, laminating, snaps, buttons, zippers, tying, hook and loop (e.g. Velcro(R)) type attachments, tacks, rivets, fasteners, etc. Some components of the devices can be exposed on the surface of the article of apparel and other fully or partially enclosed within the article.

The devices or components thereof can be constructed as part of the articles of apparel. For example, components can be printed or otherwise formed directly onto the materials that make up the articles of apparel. Components can be mounted onto the materials that make up the articles of apparel. Different components can be placed in different locations on the article of apparel. Components can be positioned in such a way as to enhance the flexibility of the device, for example.

In some cases, the wearable electronic device can comprise two or more types of components: the apparel article, at least one flexible display and/or input device (e.g. display, touchpad, touch screen, etc.), and, optionally, one or more rigid electronic components (e.g. batteries, microprocessors, USB adapters, Bluetooth adapters, Wi-Fi adapters, speakers, accelerometers, or other components, such as those disclosed above). Some or all of these other components can also be flexible. The devices can have buttons, or other control components, which can be flexible. In some cases, the flexible display and/or input device and/or control buttons can have a bending or folding angle or radius of curvature as indicated below.

In some cases, including the devices having two or more components including at least one flexible display and/or input device, the wearable electronic devices, including the can be in the form of a strap, band, belt, etc. that can be worn on the body (fastened or unfastened in position) or taken off and used unattached. In some cases the devices can be folded, bent, creased etc. for storage and transportation (such as in a bag, pocket, etc.).

The electronic devices can be made waterproof or water resistant. For example, they can be encapsulated or sealed into a waterproof or water resistant pouch. They can be sealed by vacuum sealing, heat sealing, or any suitable method. They can be washable and/or submersible. Examples of sealing materials include, but are not limited to polyurethanes.

The printed electronics can further comprise additional components, such as processors, memory chips, other microchips, batteries, resistors, diodes, capacitors, transistors, etc.

Other applications include, but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors (including gas and biosensors); liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches, batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments, etc. The electronic devices can be radiofrequency identification (RFID) devices and/or components thereof and/or radiofrequency communication device. Examples include, but are not limited to, RFID tags, chips, and antennas. The RFID devices can be near field, low frequency, high frequency, very high frequency, ultrahigh frequency, etc. RFID devices, which typically operate at frequencies in the range of about 868 to about 928 MHz. Examples of uses for RFIDs are for tracking shipping containers, products in stores, products in transit, and parts used in manufacturing processes; passports; barcode replacement applications; inventory control applications; pet identification; livestock control; contactless smart cards; automobile key fobs; etc.

The electronic devices can also be elastomeric (such as silicone) contact pads and keyboards. Such devices can be used in portable electronic devices, such as calculators, cellular telephones, GPS devices, keyboards, music players, games, etc. They can also be used in myriad other electronic applications, such as remote controls, touch screens, automotive buttons and switches, etc.

The compositions can be incorporated into articles of apparel. By apparel is meant clothing, accessories, or other articles worn by a person or other being, such as a non-human animal. Examples include clothing, footwear, headwear, accessories, etc. Examples include shirts, pants, shorts, overalls, coveralls, jackets, coats, vests, aprons, ties, cravats, gloves, mittens, gauntlets, shoes, sandals, boots, hats, caps, visors, headbands, helmets, straps, watch straps, bands, shoulder straps, wrist straps, wrist bands, leg straps, leg bands, arm bands, arm straps, cuffs, harnesses, collars, saddles, holsters, chaps, bandoliers, bracelets, belts, suspenders, bandoliers, lanyards, etc, or components thereof.

Articles can include bags and other portable storage articles such as cases, handbags, shoulder bags, laptop computer bags, backpacks, messenger bags, purses, wallets, clutches, luggage, briefcases, suitcases, cases for personal electronics such as cellphones, smart phones, tablet computers, PDAs, etc., or components thereof.

Articles can include books, diaries, furniture and upholstery (such as chairs, sofas, couches, love seats), etc., or components thereof.

The articles can be temperature control devices, heaters, heating devices, cooling devices, etc. or components thereof.

Articles can be radiation shielding, such as EMI shielding. They can be use, for example, for holding passports, chip-based cards (e.g. credit, debit, identification, etc. cards), etc. Examples can include wallets, purses, covers, handbags, cases, etc.

Articles can be components of vehicles (such as cars, trucks, motorcycles, scooters, mopeds, bicycles, forklifts, military vehicles, farm and construction vehicles and equipment, etc.) and aircraft (such as airplanes, gliders, helicopters, etc.), including interior and exterior components. They can, for example, be seats, steering wheels and steering wheel covers, heaters, interior trim, start buttons, control buttons (such as for ignition, heaters, windows, seat position, stereo or navigation systems, etc.) or components thereof in vehicles and aircraft. They can be seat, steering wheel heaters and/or coolers or components thereof. The can be biometric devices in seats. They can be safety features, such as, for example, to ensure that a driver's hands are on a steering wheel.

Apparel, bags, and other articles can be worn by animals such as pets, dogs, seeing-eye dogs and other service animals, cats, ferrets, horses, livestock, etc.

The compositions and/or materials formed from them (such as electrodes, inks and coatings, polymer composites, etc. can be electrically and/or thermally conductive. In some embodiments, the composites and/or materials formed therefrom can have a conductivity of at least about 10⁻⁸ S/m, or from about 10⁻⁶ S/m to about 10⁵ S/m, or of about 10⁻⁵ S/m to about 10⁵ S/m, or of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

n some cases, the surface resistivity of compositions and/or materials formed therefrom (including polymer composites, cured inks and coatings, etc.) can be no greater than about 10,000,000 Ω/square/mil, or no greater than about 1,000,000 Ω/square/mil, or no greater than about 100,000 Ω/square/mil, or no greater than about 50,000 Ω/square/mil, or no greater than about 25,000 Ω/square/mil, or no greater than about 10,000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

In some cases, the surface resistivity is between about 0.001 and about 5000 Ω/square/mil, or about 0.001 and about 1000 Ω/square/mil, or about 0.001 and about 500 Ω/square/mil, or about 0.001 and about 200 Ω/square/mil, or about 0.001 and about 100 Ω/square/mil, or about 0.001 and about 50 Ω/square/mil, or about 0.001 and about 40 Ω/square/mil, or about 0.001 and about 30 Ω/square/mil, or about 0.001 and about 20

Ω/square/mi or about 0.001 and about 10 Ω/square/mil, or about 0.001 and about 5 Ω/square/mi or about 0.001 and about 2 Ω/square/mil, or about 0.001 and about 1 Ω/square/mi or about 0.001 and about 0.5 Ω/square/mil, or about 0.001 and about 0.1 Ω/square/mi or about 0.001 and about 0.01 Ω/square/mil, or about 0.01 and about 5000 Ω/square/mi or about 0.01 and about 1000 Ω/square/mil, or about 0.01 and about 500 Ω/square/mi or about 0.01 and about 200 Ω/square/mil, or about 0.01 and about 100 Ω/square/mi or about 0.01 and about 50 Ω/square/mil, or about 0.01 and about 40 Ω/square/mi or about 0.01 and about 30 Ω/square/mil, or about 0.01 and about 20 Ω/square/mi or about 0.01 and about 10 Ω/square/mil, or about 0.01 and about 5 Ω/square/mi or about 0.01 and about 2 Ω/square/mil, or about 0.01 and about 1 Ω/square/mi or about 0.01 and about 0.5 Ω/square/mil, or about 0.01 and about 0.1 Ω/square/mi or about 0.1 and about 5000 Ω/square/mil, or about 0.1 and about 1000 Ω/square/mi or about 0.1 and about 500 Ω/square/mil, or about 0.1 and about 200 Ω/square/mi or about 0.1 and about 100 Ω/square/mil, or about 0.1 and about 50 Ω/square/mi or about 0.1 and about 40 Ω/square/mil, or about 0.1 and about 30 Ω/square/mi or about 0.1 and about 20 Ω/square/mil, or about 0.1 and about 10 Ω/square/mi or about 0.1 and about 5 Ω/square/mil, or about 0.1 and about 2

Ω/square/mi or about 0.1 and about 1 Ω/square/mil, or about 0.1 and about 0.5

Ω/square/mi or about 0.5 and about 5000 Ω/square/mil, or about 0.5 and about 1000 Ω/square/mi or about 0.5 and about 500 Ω/square/mil, or about 0.5 and about 200 Ω/square/mi or about 0.5 and about 100 Ω/square/mil, or about 0.5 and about 50 Ω/square/mi or about 0.5 and about 40 Ω/square/mil, or about 0.5 and about 30 Ω/square/mi or about 0.5 and about 20 Ω/square/mil, or about 0.5 and about 10 Ω/square/mi or about 0.5 and about 5 Ω/square/mil, or about 0.5 and about 2

Ω/square/mi or about 0.5 and about 1 Ω/square/mil, or about 1 and about 5000

Ω/square/mi or about 1 and about 1000 Ω/square/mil, or about 1 and about 500 Ω/square/mil, or about 1 and about 200 Ω/square/mil, or about 1 and about 100 Ω/square/mil, or about 1 and about 50 Ω/square/mil, or about 1 and about 40 Ω/square/mil, or about 1 and about 30 Ω/square/mil, or about 1 and about 20 Ω/square/mil, or about 1 and about 10 Ω/square/mil, or about 1 and about 5

Ω/square/mil, or about 1 and about 2 Ω/square/mil, or about 2 and about 5000 Ω/square/mil, or about 2 and about 1000 Ω/square/mil, or about 2 and about 500 Ω/square/mil, or about 2 and about 200 Ω/square/mil, or about 2 and about 100 Ω/square/mil, or about 2 and about 50 Ω/square/mil, or about 2 and about 40 Ω/square/mil, or about 2 and about 30 Ω/square/mil, or about 2 and about 20 Ω/square/mil, or about 2 and about 10 Ω/square/mil, or about 2 and about 5

Ω/square/mil, or about 5 and about 5000 Ω/square/mil, or about 5 and about 1000 Ω/square/mil, or about 5 and about 500 Ω/square/mil, or about 5 and about 200 Ω/square/mil, or about 5 and about 100 Ω/square/mil, or about 5 and about 50 Ω/square/mil, or about 5 and about 40 Ω/square/mil, or about 5 and about 30 Ω/square/mil, or about 5 and about 20 Ω/square/mil, or about 5 and about 10

Ω/square/mil, or about 10 and about 5000 Ω/square/mil, or about 10 and about 1000 Ω/square/mil, or about 10 and about 500 Ω/square/mil, or about 10 and about 200 Ω/square/mil, or about 10 and about 100 Ω/square/mil, or about 10 and about 50 Ω/square/mil, or about 10 and about 40 Ω/square/mil, or about 10 and about 30 Ω/square/mil, or about 10 and about 20 Ω/square/mil, or about 20 and about 5000 Ω/square/mil, or about 20 and about 1000 Ω/square/mil, or about 20 and about 500 Ω/square/mil, or about 20 and about 200 Ω/square/mil, or about 20 and about 100 Ω/square/mil, or about 20 and about 50 Ω/square/mil, or about 20 and about 40 Ω/square/mil, or about 20 and about 30 Ω/square/mil, or about 30 and about 5000 Ω/square/mil, or about 30 and about 1000 Ω/square/mil, or about 30 and about 500 Ω/square/mil, or about 30 and about 200 Ω/square/mil, or about 30 and about 100 Ω/square/mil, or about 30 and about 50 Ω/square/mil, or about 30 and about 40 Ω/square/mil, or about 50 and about 5000 Ω/square/mil, or about 50 and about 1000 Ω/square/mil, or about 50 and about 500 Ω/square/mil, or about 50 and about 200 Ω/square/mil, or about 50 and about 100 Ω/square/mil, or about 100 and about 5000 Ω/square/mil, or about 100 and about 1000 Ω/square/mil, or about 100 and about 500 Ω/square/mil, or about 100 and about 200 Ω/square/mil, or about 200 and about 5000 Ω/square/mil, or about 200 and about 1000 Ω/square/mil, or about 200 and about 500 Ω/square/mil, or about 500 and about 5000 Ω/square/mil, or about 500 and about 1000 Ω/square/mil, or about 1000 and about 5000 Ω/square/mil.

In some embodiments, the compositions and/or materials formed therefrom can have a thermal conductivity of about 0.1 to about 50 W/m·K, or of about 0.5 to about 30 W/m·K, or of about 0.1 to about 0.5 W/m·K, or of about 0.1 to about 1 W/m·K, or of about 0.1 to about 5 W/m·K, or of about 0.5 to about 2 W/m·K, or of about 1 to about 5 W/m·K, or of about 0.1 to about 0.5 W/m·K, or of about 0.1 to about 50 W/m·K, or of about 1 to about 30 W/m·K, or of about 1 to about 20 W/m·K, or of about 1 to about 10 W/m·K, or of about 1 to about 5 W/m·K, or of about 2 to about 25 W/m·K, or of about 5 to about 25 W/m·K, or of at least about 0.7 W/m·K, or of at least 1 W/m·K, or of at least 1.5 W/m·K, or of at least 3 W/m·K, or of at least 5 W/m·K, or of at least 7 W/m·K, or of at least 10 W/m·K, or of at least 15 W/m·K.

1. A method of making a composition, comprising blending a mixture comprising graphene sheets, one or more cyclic compounds having at least one ring having two or more conjugated double and/or triple bonds, and at least one solvent, wherein the one or more cyclic compounds have a solubility of no more than about 30 percent, based on the weight of the one or more cyclic compounds and solvent.

2. The method of claim 1, wherein the aromatic compound is a polyaromatic compound.

3. The method of claim 1, wherein the one or more cyclic compounds have a solubility of no more than about 10 percent.

4. The method of claim 1, wherein the one or more cyclic compounds have a solubility of no more than about 5 percent.

5. The method of claim 1, wherein the one or more cyclic compounds have a solubility of no more than about 1 percent

6. The method of claim 1, wherein the blending is done by grinding.

7. The method of claim 1, wherein the blending is done by ball milling.

8. The method of claim 1, wherein the blending step is done by ultrasonication.

9. The method of claim 1, wherein the cyclic compound is anthracene.

10. The method of claim 1, wherein the cyclic compound is one or more selected from the group consisting of acenaphthene, acenaphthylene, acenaphthene, anthracene, azulene, biphenylene, benz[a]anthracene, benz[b]anthracene (tetracene), benzo[a]pyrene, benzo[e]pyrene, benzo[b]fluoranthene, benzo[k]fluoranthene, 2,3-benzofluorene, 11H-benzo[a]fluorene, benzo[ghi]perylene, benzo[j]fluoranthene, benzo[k]fluoranthene, chrysene, comannulene, coronene, cyclopenta[d,e,f]phenanthrene, dibenz(a,h)anthracene, dibenzosuberane, 9,10-diphenylanthracene, dodecahydrotriphenylene, fluoranthene, fluorene, fulvene, fulvalene, helicene, 1,2,3,6,7,8-hexahydropyrene, indene, indeno(1,2,3-cd)pyrene, ovalene, naphthalene, naphtho[2,3-a]pyrene, pentacene, perylene, phenanthrene, pyrene, rubrene, triphenylene, 5,10,15,20-tetraphenylbisbenz[5,6]indeno[1,2,3-cd:1′,2′,3′-lm]perylene (DBC), perylene-3,4,9,10-tetracarboxylic dianhydride, perylenedicarboximide, 1,4,5,8-naphthalenetetracarboxylic dianhydride, 1,4,5,8-naphthalenetetracarboxylic acid 1,8-monoanhydride, 1,8-naphthalic anhydride, 9,10-dihydrobenzo[a]pyrene-7(8H)-one, perylene-3,4,9,10-tetracarboxylic dianhydride, 7,8,9,10-tetrahydrobenzo[a]pyren-7-ol, 9,10-phenanthrenequinone, quinizarin, 5,8-dihydroxy-1,4-naphthoquinone, anthraquinone, and 2,3-diphenylmaleic anhydride.

11. The method of claim 1, wherein the cyclic compound is present in from about 1 to about 10 percent, based on the weight of cyclic compound and graphene sheets.

12. The method of claim 1, wherein the composition further comprises graphite sheets.

13. The method of claim 11, wherein the cyclic compound is present in from about 1 to about 10 percent, based on the weight of cyclic compound, graphene sheets, and graphite.

14. The method of claim 1, wherein the composition further comprises carbon black.

15. The method of claim 1, wherein the graphene sheets have a surface area of at least about 400 mg/m².

16. An ink or coating comprising the composition of claim 1.

17. The ink or coating of claim 16, wherein the ink or coating has an electrical conductivity of at least about 50 S/m.

18. An article comprising the composition of claim 1.

19. The article of claim 18 in the form of a printed electronic device.

20. The article of claim 18 in the form of a polymer composite.
